(19) United States
(12) Patent Application Publication
(10) Pub. No.: US 2010/0250635 A1
(43) Pub. Date: Sep. 30, 2010

(54) VECTOR MULTIPLICATION PROCESSING DEVICE, AND METHOD AND PROGRAM THEREOF

(76) Inventor: TAKASHI OSADA, Yamanashi (JP)

Correspondence Address: Mr. Jackson Chen, 6535 N. STATE HWY 161, IRVING, TX, 75039, US

(21) Appl. No.: 12/730,995

(22) Filed: Mar. 24, 2010

(30) Foreign Application Priority Data
Mar. 31, 2009 (JP) 2009-086006

(51) Int. Cl. G06F 7/487; G06F 17/16

(52) U.S. Cl. 708/205; 708/498; 708/607

(57) ABSTRACT

Intended is to reduce power consumption without requiring shift of an operand. A vector multiplication processing device comprising a speed-up circuit (a fixed point overflow foresight circuit 5 and a sticky bit foresight circuit 6) to calculate a product of a first operand and a second operand input based on a multiplication instruction, which device comprises a multiplication circuit 4 (a partial product generation circuit 41 and a partial product control circuit 42) which uses the speed-up circuit and generates a partial product of the first operand and the second operand input to suppress circuit operation in a specific range resultingly not referred to related to generation of the partial product according to the multiplication instruction and a data format.

### INCORPORATION BY REFERENCE

This application is based upon and claims the benefit of priority from Japanese patent application No. 2009-086006, filed on Mar. 31, 2009, the disclosure of which is incorporated herein in its entirety by reference.

### TECHNICAL FIELD

The present invention relates to a vector multiplication processing device, and a method and a program thereof and, more particularly, to a technique of coping with a plurality of data formats by one multiplication circuit.

### BACKGROUND ART

For speeding up multiplication result calculation, a vector multiplication processing device capable of copying with a plurality of data formats by one multiplication circuit is mounted with a dedicated hardware circuit for overflow foresight processing of a fixed point data format or sticky bit foresight processing of a floating point data format.

For example, disclosed in Patent Literature 1 is a floating point multiplier mounted with a sticky bit foresight circuit of a floating point data format, which executes high-speed arithmetic by generating a sticky bit in parallel with multiplication operation of a mantissa part of floating point data.

Disclosed in Patent Literature 2 is a technique of, in an array multiplier formed of a partial product array including a plurality of array elements, reducing the number of array elements for use in calculation of an operand product by shifting an operand smaller than a corresponding size of the partial product array toward the most significant element of the array or toward a column.

Patent Literature 1: Japanese Patent Laying-Open No. 2000-259394.

Patent Literature 2: Japanese Patent Laying-Open No. 2008-533617.

According to the technique disclosed in the above-described Patent Literature 1, since the foregoing processing is determined based on an output of a multiplication circuit, with such a speed-up circuit mounted, even when arithmetic operation is executed at a partial product generation circuit in the multiplication circuit, there exists a region resultingly not referred to. In a case of a vector multiplier, successive arithmetic operation by pipelining processing with respect to a vector element makes the circuit constantly operate for each element, which is one factor in increasing power consumption.

On the other hand, while the technique disclosed in Patent Literature 2 avoids the above-described problem, shifting a multiplicand or a multiplicator, or both of them generates an array element not used, so that a circuit element therefor is required and a processing load therefor is required as well.

### OBJECT OF INVENTION

An object of the present invention is to provide a vector multiplication processing device, and a method and a program thereof which realize, when a speed-up circuit is mounted, reduction in power consumption without requiring shift of an operand by directly suppressing a region not to be referred to as a result even if a partial product generation circuit in a multiplication circuit executes arithmetic operation by means of the partial product generation circuit.

### SUMMARY

According to a first exemplary aspect of the invention, a vector multiplication processing device which calculates a product of a first operand and a second operand input based on a multiplication instruction, includes an overflow foresight circuit of a fixed point data format, a sticky bit foresight circuit of a floating point data format, and a multiplication circuit including a partial product generation circuit which uses the overflow foresight circuit and the sticky bit foresight circuit to generate a partial product of a first operand and a second operand input and a partial product control circuit which suppresses operation of the partial product generation circuit in a specific region resultingly not referred to related to generation of the partial product according to the multiplication instruction and data format.

According to a second exemplary aspect of the invention, a vector multiplication processing method for use in a vector multiplication processing device including a multiplication circuit which calculates a product of a first operand and a second operand input based on a multiplication instruction, wherein the multiplication circuit includes a partial product generation step of generating a partial product of input first operand and second operand by using an overflow foresight circuit of a fixed point data format and a sticky bit foresight circuit of a floating point data format, and a circuit operation suppression step of suppressing circuit operation in a specific region resultingly not referred to related to generation of the partial product according to the multiplication instruction and data format.

According to a third exemplary aspect of the invention, a vector multiplication processing program of a vector multiplication processing device executed on a computer, which device comprises at least an overflow foresight circuit of a fixed point data format and a sticky bit foresight circuit of a floating point data format to calculate a product of a first operand and a second operand input based on a multiplication instruction, includes a partial product generation processing of generating a partial product of input first operand and second operand by using the overflow foresight circuit and sticky bit foresight circuit, and a circuit operation suppression processing of suppressing circuit operation in a specific region resultingly not referred to related to generation of the partial product according to the multiplication instruction and data format.

The present invention enables provision of a vector multiplication processing device, and a method and a program thereof which realize, when a speed-up circuit is mounted, reduction in power consumption without requiring shift of an operand by directly suppressing a region not to be referred to as a result even if a partial product generation circuit in a multiplication circuit executes arithmetic operation by means of the partial product generation circuit.

The reason is that the partial product control circuit suppresses circuit operation in a specific range resultingly not referred to related to an output of the partial product circuit according to a multiplication instruction and a data format.

### BRIEF DESCRIPTION OF THE DRAWINGS

FIG. 1 is a block diagram showing an internal structure of a vector multiplication processing device according to a first exemplary embodiment of the present invention;

FIG. 2 is a block diagram showing an internal structure of a multiplication circuit of a vector multiplication processing device according to the first exemplary embodiment of the present invention;

FIG. 3 is a schematic diagram for use in explaining operation of generating a partial product of fixed point 64 bits in the vector multiplication processing device according to the first exemplary embodiment of the present invention;

FIG. 4 is a schematic diagram for use in explaining operation of generating a partial product of fixed point 32 bits in the vector multiplication processing device according to the first exemplary embodiment of the present invention;

FIG. 5 is a schematic diagram for use in explaining operation of generating a partial product of floating point double precision 53 bits in the vector multiplication processing device according to the first exemplary embodiment of the present invention;

FIG. 6 is a schematic diagram for use in explaining operation of generating a partial product of floating point single precision 24 bits in the vector multiplication processing device according to the first exemplary embodiment of the present invention;

FIG. 7 is an internal circuit diagram of a multiplication circuit (one bit of a partial product generation circuit) of the vector multiplication processing device according to the first exemplary embodiment of the present invention;

FIG. 8 is a diagram showing one example of a multiplication instruction and a data format for use in the vector multiplication processing device according to the first exemplary embodiment of the present invention;

FIG. 9 is a block diagram showing an internal structure of a vector multiplication processing device according to a second exemplary embodiment of the present invention; and

FIG. 10 is a diagram showing, in a table form, kinds of control patterns discriminated by a multiplication instruction and a data format for use in the vector multiplication processing device according to the first exemplary embodiment of the present invention and kinds of non-numeric values according to the second exemplary embodiment.

### EXEMPLARY EMBODIMENT

Next, exemplary embodiments of the present invention will be described in detail with reference to the drawings.

### Structure of First Exemplary Embodiment

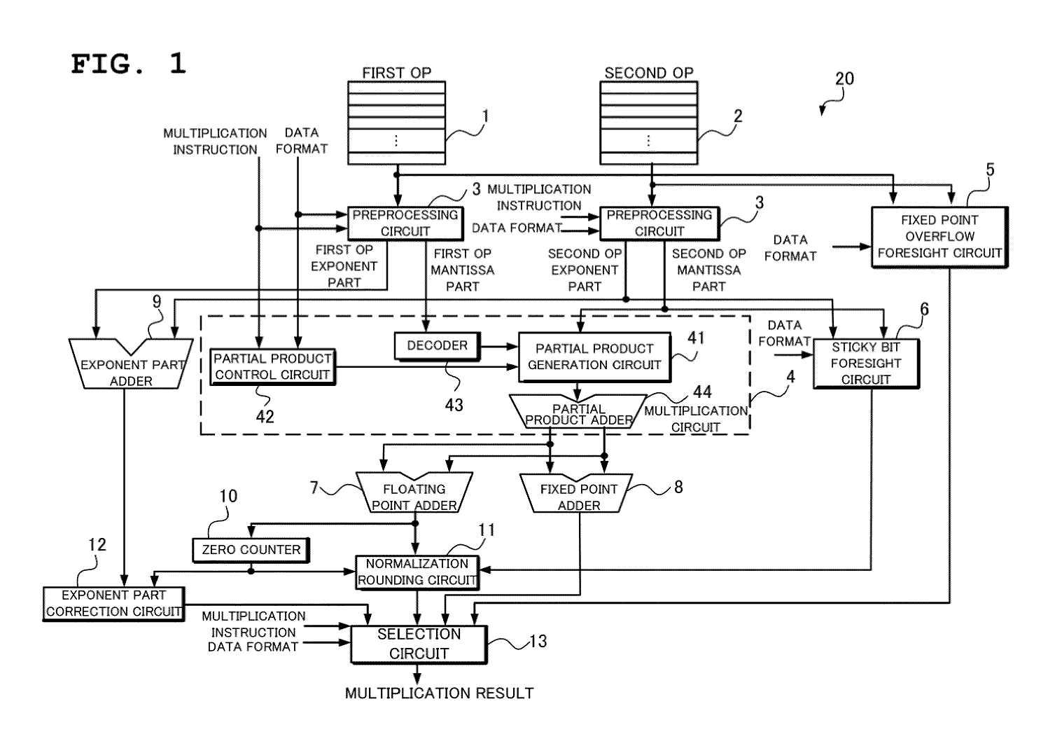

FIG. 1 is a block diagram showing a structure of a vector multiplication processing device according to a first exemplary embodiment of the present invention.

With reference to FIG. 1, a vector multiplication processing device 20 according to the present exemplary embodiment includes a vector register 1, a vector register 2, a preprocessing circuit 3, a multiplication circuit 4, a fixed point overflow foresight circuit 5, a sticky bit foresight circuit 6, a floating point adder 7, a fixed point adder 8, an exponent part adder 9, a zero counter 10, a normalization rounding circuit 11, an exponent part correction circuit 12 and a selection circuit 13.

The vector register 1 is connected to the preprocessing circuit 3 and the fixed point overflow foresight circuit 5 and stores a first operand (OP). The vector register 2 is connected to the preprocessing circuit 3 and the fixed point overflow foresight circuit 5 and stores a second operand. The preprocessing circuit 3 is connected to the vector register 1 or the vector register 2, and the multiplication circuit 4, the sticky bit foresight circuit 6 and the exponent part adder 9 and divides an operand supplied from the vector register 1 or the vector register 2 into an exponent part and a mantissa part according to a multiplication instruction and a data format.

The multiplication circuit 4 is connected to the preprocessing circuit 3, the floating point adder 7 and the fixed point adder 8 and multiplies mantissa parts which are outputs of the preprocessing circuit 3 to output a multiplication result to the floating point adder 7 and the fixed point adder 8.

The fixed point overflow foresight circuit 5 is connected to the vector register 1, the vector register 2 and the selection circuit 13 and with the first operand and the second operand as an input, foresees whether a fixed point multiplication result overflows or not. The sticky bit foresight circuit 6 is connected to the preprocessing circuit 3 and the normalization rounding circuit 11 and with a first operand mantissa part and a second operand mantissa part as an input, foresees a sticky bit for use in rounding processing out of floating point multiplication results.

The floating point adder 7 is connected to the multiplication circuit 4, the zero counter 10 and the normalization rounding circuit 11 and adds two outputs of the multiplication circuit 4 to output a result to the zero counter 10 and the normalization rounding circuit 11. The fixed point adder 8 is connected to the multiplication circuit 4 and the selection circuit 13 and adds two outputs of the multiplication circuit 4 to output an effective digit out of the addition results to the selection circuit 13. The output of the fixed point adder 8 will be a fixed point multiplication result.

The exponent part adder 9 is connected to the preprocessing circuit 3 and the exponent part correction circuit 12 and executes determination of a code as an output of the preprocessing circuit 3 and addition of exponent parts to output the code and an exponent addition result to the exponent part correction circuit 12. The zero counter 10 is connected to the floating point adder 7, the normalization rounding circuit 11 and the exponent part correction circuit 12 and with an output of the floating point adder 7 as an input, counts the number of bits 0 from a most significant bit (MSB) and outputs the count to the normalization rounding circuit 11 and the exponent part correction circuit 12.

The normalization rounding circuit 11 is connected to the sticky bit foresight circuit 6, the floating point adder 7, the zero counter 10 and the selection circuit 13 and according to the output of the zero counter 10, shifts and normalizes an output of the floating point adder 7 and furthermore, with an output of the sticky bit foresight circuit 6 as an input, executes rounding processing to output a result to the selection circuit 13. The output of the normalization rounding circuit 11 will be a mantissa part of the floating point multiplication result. The exponent part correction circuit 12 is connected to the exponent part adder 9, the zero counter 10 and the selection circuit 13 and according to the output of the zero counter 10, corrects an exponent part addition result out of the output of the exponent part adder 9. The output of the exponent part correction circuit 12 will be an exponent part of the floating point multiplication result.

The selection circuit 13 is connected to the fixed point overflow foresight circuit 5, the fixed point adder 8, the normalization rounding circuit 11 and the exponent part correction circuit 12 and when a multiplication instruction indicates floating point multiplication, links a code and an exponent part output of the exponent correction circuit 12 and a mantissa part output of the normalization rounding circuit 11 to output a floating point multiplication result. When the multiplication instruction indicates fixed point multiplication, output the output of the fixed point adder 8 as a fixed point arithmetic result. When at this time, the output of the fixed point overflow foresight circuit 5 indicates overflow, output a predetermined format (the maximum number etc.) as an arithmetic result of the fixed point multiplication.

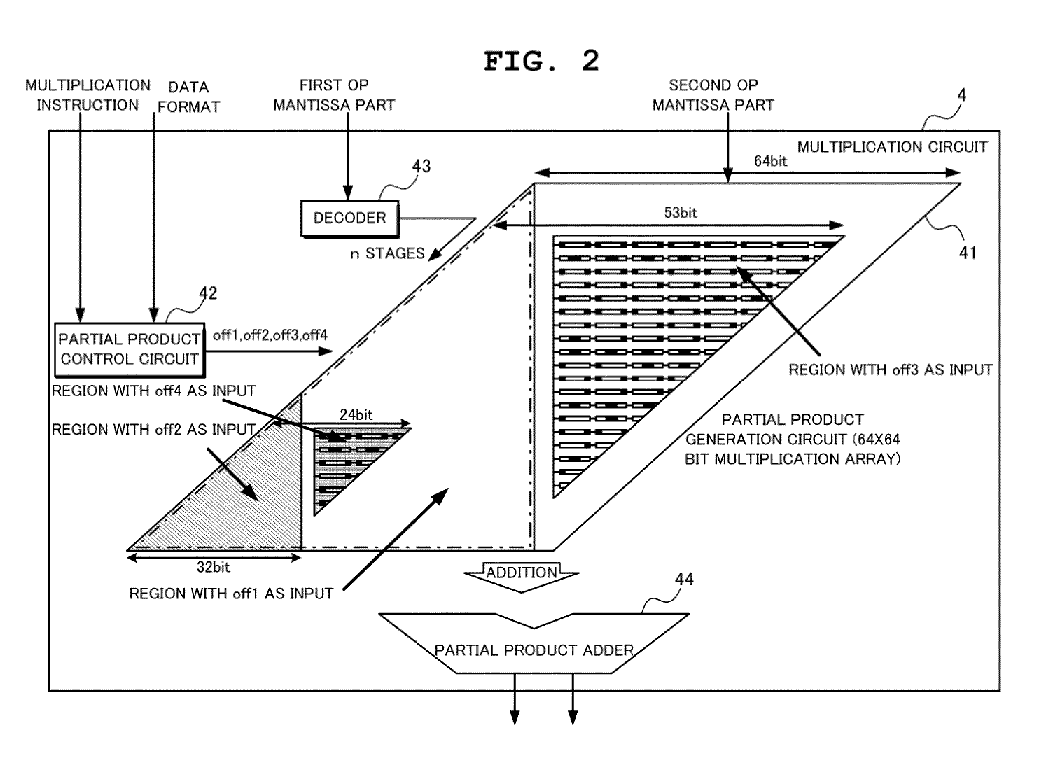

FIG. 2 is a diagram for use in explaining details of an internal structure of the multiplication circuit 4 shown in FIG. 1. With reference to FIG. 2, the multiplication circuit 4 includes a partial product generation circuit 41 formed, for example, of a 64×64 bit multiplication array, a partial product control circuit 42, a decoder 43 and a partial product adder 44.

With reference to FIG. 2, the decoder 43 is connected to the preprocessing circuit 3 and the partial product generation circuit 41 and with a mantissa part of the first operand as an input, executes recoding to output a decoding signal to the partial product generation circuit 41.

The partial product control circuit 42 is connected to the partial product generation circuit 41 and obtains a multiplication instruction and a data format as an input to generate a control signal (off1, off2, off3, off4) and output the same to the partial product generation circuit 41. The partial product generation circuit 41 is connected to the preprocessing circuit 3, the partial product control circuit 42, the decoder 43 and the partial product adder 44 and obtains a mantissa part of the second operand as an input to generate a partial product with the second operand mantissa part multiplied based on a decoding signal sent from the decoder 43 and the off signal output from the partial product control circuit 42.

The partial product adder 44 is connected to the partial product generation circuit 41, the floating point adder 7 and the fixed point adder 8 and adds a number n of partial products as outputs of the partial product generation circuit 41 until the remaining number of the partial products goes two to output ultimately obtained two partial products to the floating point adder 7 and the fixed point adder 8.

### Operation of the First Exemplary Embodiment)

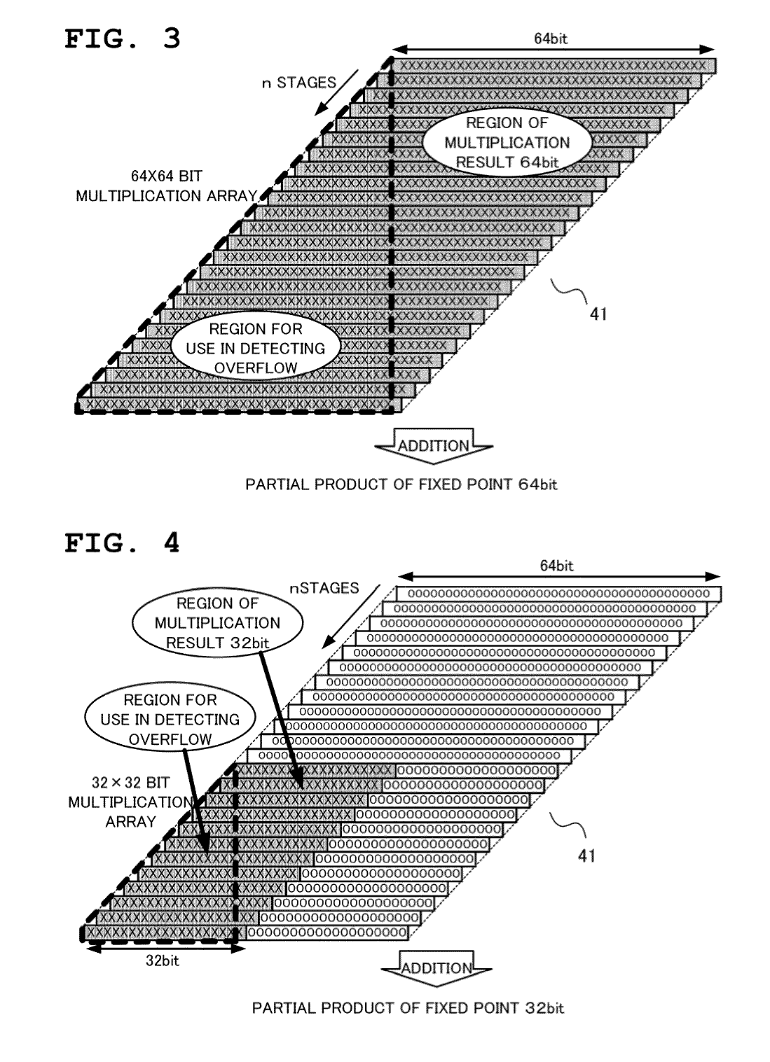

Next, operation of the vector multiplication processing device 20 according to the present exemplary embodiment will be detailed with reference to FIG. 3 through FIG. 8 and FIG. 10(a).

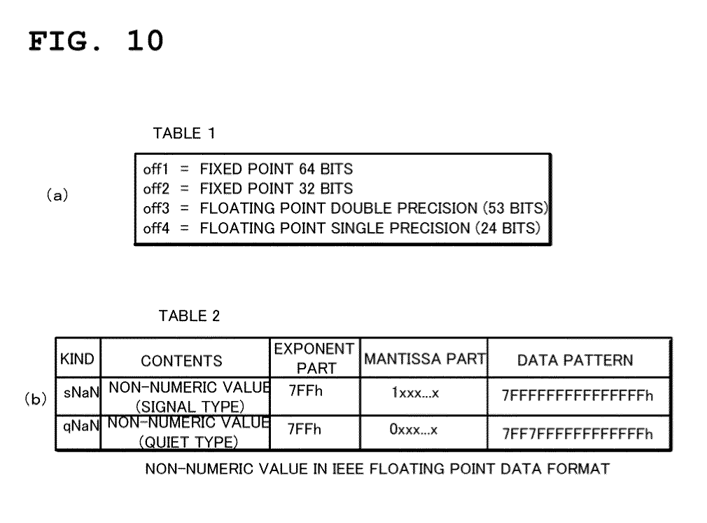

The vector multiplication processing device 20 according to the present exemplary embodiment executes floating point multiplication and fixed point multiplication of vector data by the same hardware according to a multiplication instruction and a data format. Here, description will be made of a vector multiplication processing device, as an example, which copes with a total of four control pattern (see FIG. 10(a) which will be described later) formats formed of a combination of 64 bits and 32 bits of fixed point data formats in addition to a double precision and a single precision of the IEEE floating point data formats shown in FIG. 8(a) through (d) which will be described later.

First, description will be made of operation to be executed when fixed point multiplication is executed with reference to the schematic diagrams of the multiplication array 41 shown in FIG. 3 and FIG. 4.

It is assumed that a multiplication instruction to be sent to the above-described preprocessing circuit 3, multiplication circuit 4 and selection circuit 12 is designated to be “fixed point multiplication” and a data format is designated to be “64 bits” or “32 bits”. At this time point, according to the multiplication instruction and the data format, the preprocessing circuit 3 here outputs “0” as an exponent part to the exponent adder 9 because of fixed point multiplication and in a case of fixed point multiplication 64 bits, outputs all the bits of the first and the second operands as a mantissa part as shown, for example, in FIG. 8(a) to the multiplication circuit 4 and in a case of fixed point multiplication 32 bits, adds less significant 32 bits of “0” to effective digit 32 bits of the first and the second operands and outputs the addition result as a mantissa part as shown in FIG. 8(b) to the multiplication circuit 4.

With the input first operand mantissa part of 64 bits as a multiplicator and the second operand mantissa part as a multiplicand, the multiplication circuit 4 aligns a result (partial products) obtained by multiplying each bit of the multiplicator by the multiplicand in n stages (multiplication array) in a form of binary calculation by writing as shown in FIG. 3 and FIG. 4 and adds the same to obtain a product. FIG. 3 shows a partial product of fixed point 64 bits. With reference to FIG. 3, out of the respective partial products, a region of less significant 64 bits will be a multiplication result of the fixed point multiplication 64 bits and more significant 64 bits indicated by dotted lines will be used for detecting overflow.

In the vector multiplication processing device 20 according to the present exemplary embodiment, the fixed point overflow foresight circuit 5 foresees whether a fixed point multiplication result overflows or not with the first and second operands as an input and outputs the result to the selection circuit 12. Therefore, the region indicated by the dotted line in FIG. 3 will be referred to by none of circuits to follow. As a result, a region equivalent to a half of the entire multiplication array will be a region yet to be referred to.

As to foresight of an overflow of fixed point multiplication, it is known that the number of bits “0” from MSB of each input data is counted and when the total is within a fixed number, overflow occurs. FIG. 4 shows a partial product of fixed point 32 bits. Out of the region of the 32×32 bit multiplication array, a region of less significant 32 bits will be a multiplication result of fixed point multiplication 32 bits and more significant 32 bits indicated by the dotted lines are used for detection of overflow. Since similarly to a case of fixed point multiplication 64 bits, in the vector multiplication processing device according to the present exemplary embodiment, the fixed point overflow foresight circuit 5 foresees whether a fixed point multiplication result overflows or not, the region indicated by the dotted lines in FIG. 4 will be referred to by none of the circuits to follow. Accordingly, a region equivalent to one-eighth the entire multiplication array will be a region yet to be referred to.

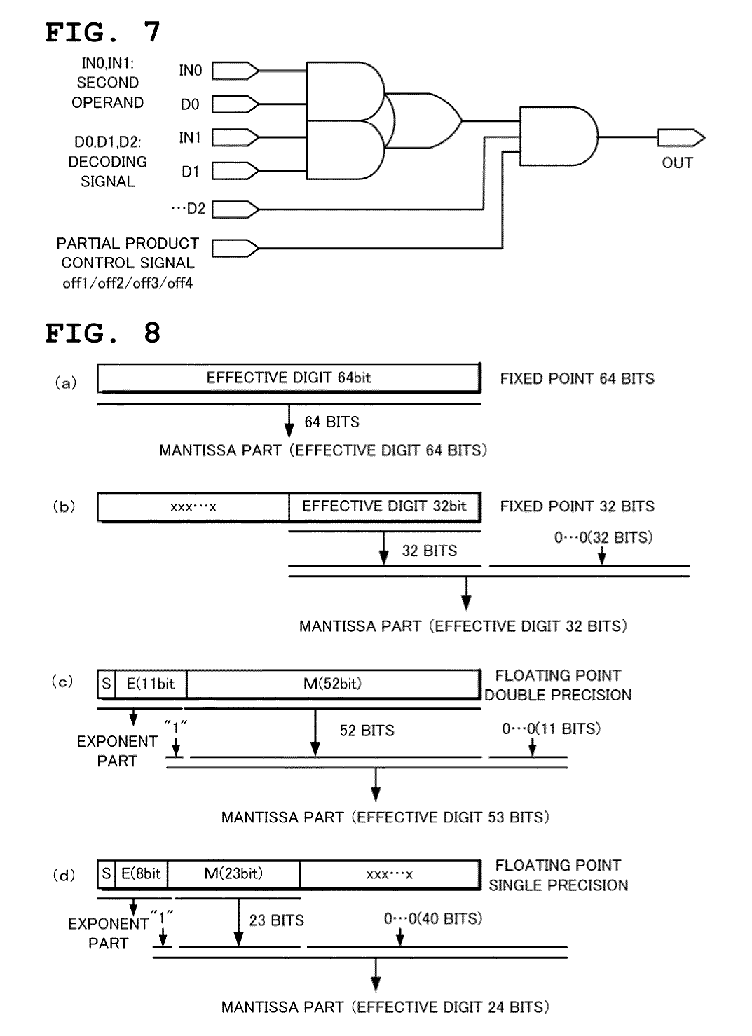

In the structure of the multiplication circuit 4 shown in FIG. 2, the decoder 43 executes recoding processing with the first operand mantissa part as an input to transmit a decoding signal to the partial product generation circuit 41. With the second operand mantissa part as an input, the partial product generation circuit 41 generates a partial product obtained by multiplying the decoding signal sent from the decoder 43 by an off signal sent from the partial product control circuit 42 and the second operand mantissa part and aligns the same in n stages in the form of calculation by writing. At this time, one bit of the partial product generation circuit 41 has an AND gate having an off signal as an input in a logical gate as shown in FIG. 7.

In FIG. 6, the partial product control circuit 42 generates an off signal with a multiplication instruction and a data format as an input and distributes the same to the partial product generation circuit 41. As illustrated in a Table 1 in FIG. 10(a), the off signal is classified, for example, into four control patterns, off1, off2, off3 and off4, by a multiplication instruction and a data format. It is assumed that in a case of fixed point multiplication 64 bits, the off1 signal is generated and in a case of fixed point multiplication 32 bits, the off2 signal is generated. Each off signal is assumed to attain “0” when it is effective.

With reference to FIG. 7, when an effective off signal (whose value is 0) is applied to the partial product generation circuit 41, the output is maintained at “0”. As a result, in a case of fixed point multiplication 64 bits, a region with the off1 signal as an input in FIG. 6 and in a case of fixed point multiplication 32 bits, a region with the off2 signal as an input all attain “0” as an output.

Return the description to FIG. 2. As to each partial product as an output of the partial product generation circuit 41, a number n of partial products are added by the partial product adder 44 until the remaining number of the partial products goes two and the ultimately obtained two partial products are output to the floating point adder 7 and the fixed point adder 8. At the time of this addition processing, a region whose output is maintained at “0” by the partial product generation circuit 41 fails to operate. In FIG. 1, the fixed point adder 8 adds two outputs of the multiplication circuit 4 as an input and outputs a part of an effective digit out of the addition result to the selection circuit 12. The output of the fixed point adder 8 will be a fixed point multiplication result. The selection circuit 12 outputs the output of the fixed point adder 8 as fixed point multiplication. When at the time of output of the arithmetic result, the output of the fixed point overflow foresight circuit 5 indicates overflow, a predetermined format (maximum number) is output as a fixed point multiplication result.

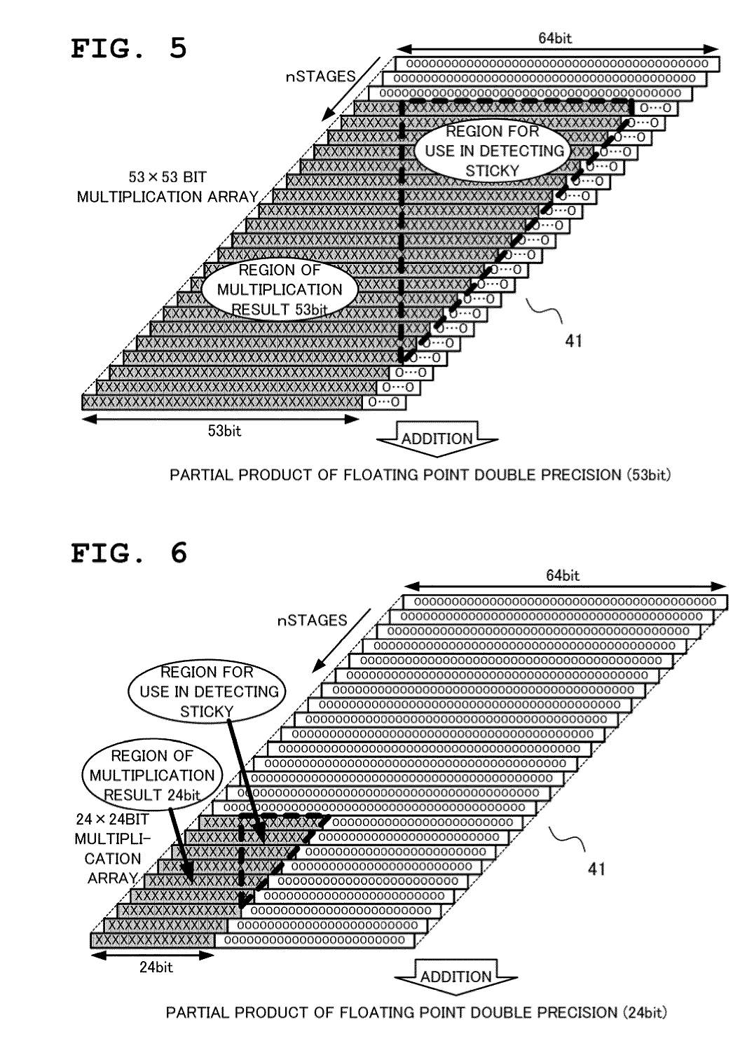

Next, operation at the time of execution of floating point multiplication will be described with reference to the schematic diagrams of the multiplication arrays shown in FIG. 5 and FIG. 6. At this time, as a multiplication instruction sent to the preprocessing circuit 3, the multiplication circuit 4 and the selection circuit 12, “floating point multiplication” is designated and as a data format, “64 bits (double precision)” or “32 bits (single precision)” is designated.

According to the multiplication instruction and the data format, in a case, for example, of a floating point multiplication double precision as shown in FIG. 8(c), the preprocessing circuit 3 outputs, to the exponent part adder 9, a total of 12 bits including a code (S) of one bit and an exponent part (E) of 11 bits as an exponent part and in a case of a floating point multiplication single precision, a total of 9 bits including the code (S) of one bit and the exponent part (E) of 8 bits as an exponent part.

In a case of a floating point multiplication double precision, the mantissa part (M) of 52 bits of the first and second operands and 11 bits of “0” are added to the top hidden bit “1” of the mantissa part in the expression in the IEEE floating point data format as shown in FIG. 8(c) and the result of the addition is output as a mantissa part to the multiplication circuit 4. In a case of the floating point multiplication single precision, the mantissa part of 23 bits of the first and second operands and 40 bits of “0” are added to the top hidden bit “1” of the mantissa part in the expression in the IEEE floating point data format and the addition result is output as a mantissa part to the multiplication circuit 4. The exponent parts of the first and second operands generated by the preprocessing circuit 3 have their codes determined and have their addition of the exponent parts by the exponent part adder 9, and the obtained code and the exponent part addition result are output to the exponent part correction circuit 12.

With the input first operand mantissa part of 64 bits as a multiplicator and the second operand mantissa part as a multiplicand, the multiplication circuit 4 aligns partial products obtained by multiplying each bit of the multiplicator by the multiplicand in n stages in a form of binary calculation by writing as shown in FIG. 5 and FIG. 6 and adds the same to obtain a product. FIG. 5 shows a partial product of floating point double precision. Out of the respective partial products, a region of more significant 53 bits will be a multiplication result of the floating point multiplication 53 bits, and 54th and 55th bits will be a round bit and a guard bit for use in rounding processing of IEEE floating point multiplication. Less significant 51 bits indicated by the dotted lines are used for detecting a sticky bit for use in the rounding processing of IEEE floating point multiplication.

In the structure of the vector multiplication processing device 20 according to the present exemplary embodiment, since the sticky bit foresight circuit 6 foresees a sticky bit with the first and second operands as an input and outputs the result to the normalization rounding circuit 11, the region indicated by the dotted lines in FIG. 5 will be referred to by none of circuits to follow. As a result, a region about 34% of the entire multiplication array will be a region yet to be referred to.

FIG. 6 shows a partial product of floating point single precision. Here, out of the region of the 24×24 bit multiplication array, a region of more significant 24 bits will be a multiplication result of floating point multiplication 24 bits, and 25th and 26th bits will be a round bit and a guard bit for use in rounding processing of IEEE floating point multiplication. The less significant 22 bits indicated by the dotted lines are used for detecting a sticky bit for use in IEEE floating point rounding processing. Since similarly to a case of floating point multiplication 53 bits, the sticky bit foresight circuit 6 foresees a sticky bit, the region indicated by the dotted lines in FIG. 6 will be referred to by none of the circuits to follow. Accordingly, a region about 6% of the entire multiplication array will be a region yet to be referred to. Method of foreseeing a sticky bit is disclosed in detail in the above-described Patent Literature 1.

Return the description to FIG. 2. FIG. 2 is a block diagram showing details of an internal structure of the multiplication circuit 4 and as described above, the decoder 43 executes recoding processing with the first operand mantissa part as an input to output a decoding signal to the partial product generation circuit 41. The partial product generation circuit 41 generates a partial product obtained by multiplying the decoding signal sent from the decoder 43 which receives input of the second operand mantissa part by the second operand mantissa part and aligns the same in n stages in the form of calculation by writing. At this time, one bit of the partial product generation circuit 41 has an AND gate having an off signal as an input in a logical gate as shown in FIG. 7. The partial product control circuit 42 generates an off signal with a multiplication instruction and a data format as an input and distributes the same to the partial product generation circuit 41. As illustrated in the Table 1 in FIG. 10(a), the off signal is classified, for example, into the four control patterns, off1, off2, off3 and off4, by a multiplication instruction and a data format.

In a case of floating point multiplication double precision, the off3 signal is generated. In a case of floating point multiplication single precision, the off4 signal is generated. Each off signal is assumed to attain “0” when it is effective. When to one bit of the partial product generation circuit 41 in FIG. 7, an effective off signal (whose value is 0) is applied, the output is maintained at “0”. As a result, in a case of floating point multiplication double precision, a region with the off3 signal as an input in FIG. 6 and in a case of floating point multiplication single precision, a region with the off4 signal as an input all attain “0” as an output.

In FIG. 7, as to each partial product as an output of the partial product generation circuit 41, a number n of partial products are added by the partial product adder 44 until the remaining number of the partial products goes two and the ultimately obtained two partial products are output to the floating point adder 7 and the fixed point adder 8. At the time of this addition processing, a region whose output is maintained at “0” by the partial product generation circuit 41 fails to operate. In FIG. 1, the floating point adder 7 adds two outputs of the partial product adder 44 and transmits the addition result to the normalization rounding circuit 11 and the zero counter 10. The number of bits “0” is counted by the zero counter 10 from MSB as the addition result to obtain the number of shifts for normalization. The number of shifts is sent to the normalization rounding circuit 11 to execute normalization and rounding of a mantissa part by the normalization rounding circuit 11 together with a sticky bit sent from the sticky bit foresight circuit 6. The output of the normalization rounding circuit 11 will be a mantissa part of the floating point multiplication result.

At this time, the number of shifts as the output of the zero counter 10 is output also to the exponent part correction circuit 12, which exponent part correction circuit 12 corrects the exponent part to obtain a code and an exponent part of the floating point multiplication result. The selection circuit 13 combines the output of the exponent part correction circuit 12 and the output of the normalization rounding circuit 11 and outputs the obtained result as an arithmetic result of the floating point multiplication.

### Effects of the First Exemplary Embodiment

First effect obtained by the present invention is reduction in power consumption of a vector multiplication processing device which supports a plurality of data formats by one multiplication circuit.

The reason is that by controlling operation of the partial product generation circuit in the multiplication circuit on a basis of a multiplication instruction and a data format, operation of a region resultingly not referred to related to an output of the partial product generation circuit is suppressed.

### Structure of Second Exemplary Embodiment

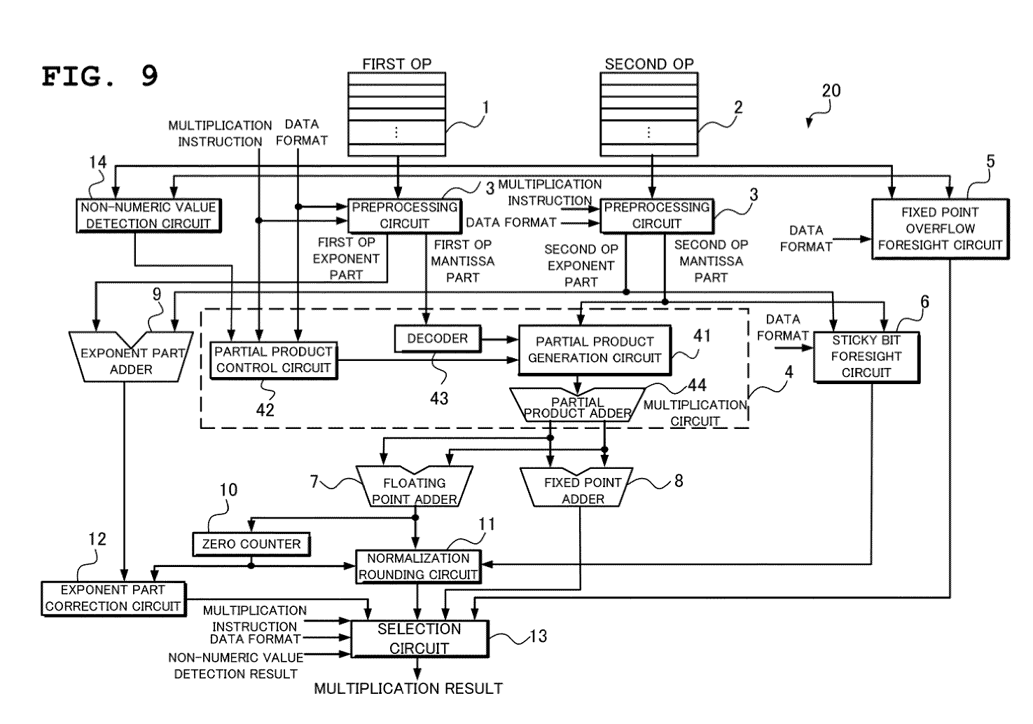

Next, the vector multiplication processing device 20 according to a second exemplary embodiment of the present invention will be described with reference to a structural diagram of the vector multiplication processing device 20 shown in FIG. 9.

The vector multiplication processing device 20 according to the present exemplary embodiment shown in FIG. 9 differs from that of the first exemplary embodiment shown in FIG. 1 in having a non-numeric value detection circuit 14 provided between the vector register 1 and the vector register 2, and the multiplication circuit 4. The non-numeric value detection circuit 14 detects a non-numeric value NaN (Not a Number) of an IEEE floating point data format, for example, shown in a Table 2 in FIG. 10(b) and transmits the detection result to the partial product control circuit 42 in the multiplication circuit 4, and the selection circuit 13. Here, signal-type sNaN and quiet-type qNaN are illustrated. The remaining part of the structure is the same as that shown in FIG. 1.

### Operation of the Second Exemplary Embodiment

In IEEE floating point arithmetic, since as a result of arithmetic of a floating point, a result generated because of application of a false operand is output as a non-numeric value NaN, no result of the multiplication circuit 4 will be referred to. Accordingly, when an output of the non-numeric value detection circuit 14 is a non-numeric value at the time of a floating point multiplication instruction, supplying an off signal to all the regions of the partial product generation circuit 41 by the partial product control circuit 42 enables operation of the entire circuit following the partial product generation circuit 41 to be stopped, thereby further reducing power consumption.

### Effects of the Second Exemplary Embodiment

According to the vector multiplication processing device 20 according to the present exemplary embodiment, by detecting a non-numeric value of an IEEE floating point data format and when a non-numeric value is detected, supplying an off signal to all the regions of the partial product generation circuit 41 by the partial product control circuit 42 enables operation of the entire circuit following the partial product generation circuit 41 to be stopped, thereby realizing further reduction of power consumption in this case.

The functions that the multiplication circuit 4 of the vector multiplication processing device 20 shown in each of FIG. 1 and FIG. 9 may be realized all in software or at least a part of them may be realized in hardware. Data processing may be realized by one or a plurality of programs on a computer, or at least a part of it may be realized in hardware, in which data processing, the multiplication circuit 4 generates a partial product of applied first operand and second operand by using the overflow foresight circuit 5 and the sticky bit foresight circuit 6 and generates a control signal which suppresses circuit operation of a specific range resultingly not referred to related to generation of a partial product according to a multiplication instruction and a data format, thereby controlling generation of a partial product.

Although the present invention has been described with respect to the preferred exemplary embodiments and modes of implementation in the foregoing, the present invention is not necessarily limited to the above-described exemplary embodiments and modes of implementation and can be implemented in various modifications without departing from the scope of their technical ideas.

What is claimed is:

1. A vector multiplication processing device which calculates a product of a first operand and a second operand input based on a multiplication instruction, comprising:
an overflow foresight circuit of a fixed point data format;
a sticky bit foresight circuit of a floating point data format; and
a multiplication circuit including a partial product generation circuit which uses said overflow foresight circuit and said sticky bit foresight circuit to generate a partial product of a first operand and a second operand input and a partial product control circuit which suppresses operation of said partial product generation circuit in a specific region resultingly not referred to related to generation of said partial product according to said multiplication instruction and data format.

2. The vector multiplication processing device according to claim 1, wherein said partial product control circuit suppresses circuit operation in a region resultingly not referred to related to said partial product generation according to an instruction kind indicating whether said multiplication instruction is a fixed point multiplication instruction or a floating point multiplication instruction and according to a data length that said input first and second operand have.

3. The vector multiplication processing device according to claim 1, wherein
said partial product control circuit generates a control signal which suppresses circuit operation in a region resultingly not referred to related to said partial product generation according to said multiplication instruction and data format, and
said partial product generation circuit generates a partial product from a mantissa part of said second operand according to the control signal output from said partial product control circuit.

4. The vector multiplication processing device according to claim 1, comprising:
a preprocessing circuit which divides said first operand and said second operand input into an exponent part and a mantissa part according to a multiplication instruction and a data format;
a multiplication circuit including said partial product control circuit and said partial product generation circuit to multiply mantissa parts which are outputs of said preprocessing circuits respectively connected to said first operand and said second operand;
said overflow foresight circuit which foresees whether a fixed point multiplication result overflows or not with said first operand and said second operand as an input;
said sticky bit foresight circuit which generates a sticky bit with said first operand mantissa part and second operand mantissa part as an input;
an exponent part adder which executes determination of a code as an output of said preprocessing circuits respectively connected to said first operand and said second operand and addition of an exponent part;
a floating point adder which executes addition of an output of said multiplication circuit;
a fixed point adder which executes addition of an output of said multiplication circuit;
a zero counter which counts the number of bits “0” from a most significant bit part with an output of said floating point adder as an input;
a normalization rounding circuit which shifts an output of said floating point adder to execute normalization and rounding according to an output of said zero counter,
an exponent part correction circuit which corrects an output of said exponent part adder according an output of said zero counter; and
a selection circuit which, when said multiplication instruction indicates floating point multiplication, links a code and an exponent part output of said exponent part correction circuit and a mantissa part output of said normalization rounding circuit to output a floating point multiplication result and when said multiplication instruction indicates fixed point multiplication, outputs an output of said fixed point adder as a fixed point arithmetic result.

5. The vector multiplication processing device according to claim 1, comprising:
a first vector register in which said first operand is stored;
a second vector register in which said second operand is stored; and
a non-numeric value detection circuit provided between said first and second vector registers and said multiplication circuit for detecting a non-numeric value indicative of a result caused by input of a false operand, wherein
said partial product control circuit suppresses circuit operation in all the regions of said partial product generation circuit when a non-numeric value is detected by said non-numeric value detection circuit.

6. A vector multiplication processing method for use in a vector multiplication processing device including a multiplication circuit which calculates a product of a first operand and a second operand input based on a multiplication instruction, wherein said multiplication circuit includes
a partial product generation step of generating a partial product of input first operand and second operand by using an overflow foresight circuit of a fixed point data format and a sticky bit foresight circuit of a floating point data format, and
a circuit operation suppression step of suppressing circuit operation in a specific region resultingly not referred to related to generation of said partial product according to said multiplication instruction and data format.

7. The vector multiplication processing method according to claim 6, wherein at said circuit operation suppression step, operation is suppressed in a region resultingly not referred to related to said partial product generation according to an instruction kind indicating whether said multiplication instruction is a fixed point multiplication instruction or a floating point multiplication instruction and according to a data length that said input first and second operand have.

8. The vector multiplication processing method according to claim 6, wherein
at said circuit operation suppression step, a control signal is generated which suppresses operation in a region resultingly not referred to related to said partial product generation according to said multiplication instruction and data format, and
at said partial product generation step, a partial product is generated from a mantissa part of said second operand according to the control signal output at said circuit operation suppression step.

9. The vector multiplication processing method according to claim 6, comprising:
a non-numeric value detection step of detecting a non-numeric value indicative of a result caused by input of a false operand between a first vector register in which said first operand is stored and a second vector register in which said second operand is stored, and said multiplication circuit, wherein
at said circuit operation suppression step, when a non-numeric value is detected at said non-numeric value detection step, circuit operation is suppressed in all the regions related to said partial product generation.

10. A vector multiplication processing program of a vector multiplication processing device executed on a computer, which device comprises at least an overflow foresight circuit of a fixed point data format and a sticky bit foresight circuit of a floating point data format to calculate a product of a first operand and a second operand input based on a multiplication instruction, comprising:
a partial product generation processing of generating a partial product of input first operand and second operand by using said overflow foresight circuit and sticky bit foresight circuit; and
a circuit operation suppression processing of suppressing circuit operation in a specific region resultingly not referred to related to generation of said partial product according to said multiplication instruction and data format.

11. The vector multiplication processing program according to claim 10, wherein in said circuit operation suppression processing, operation is suppressed in a region resultingly not referred to related to said partial product generation according to an instruction kind indicating whether said multiplication instruction is a fixed point multiplication instruction or a floating point multiplication instruction and according to a data length that said input first and second operand have.

12. The vector multiplication processing program according to claim 10, wherein
in said circuit operation suppression processing, a control signal is generated which suppresses operation in a region resultingly not referred to related to said partial product generation according to said multiplication instruction and data format, and
in said partial product generation processing, a partial product is generated from a mantissa part of said second operand according to the control signal output in said circuit operation suppression processing.

13. The vector multiplication processing program according to claim 10, comprising:
a non-numeric value detection processing of detecting a non-numeric value indicative of a result caused by input of a false operand between a first vector register in which said first operand is stored and a second vector register in which said second operand is stored, and said multiplication circuit, wherein
in said circuit operation suppression processing, when a non-numeric value is detected in said non-numeric value detection processing, circuit operation is suppressed in all the regions related to said partial product generation.
